(19) United States
(12) Patent Application Publication
(10) Pub. No.: US 2023/0095544 A1
(43) Pub. Date: Mar. 30, 2023

(54) CONTROL DEVICE, IMAGE FORMING APPARATUS, AND NON-TRANSITORY COMPUTER READABLE MEDIUM STORING CONTROL PROGRAM

(71) Applicant: FUJIFILM Business Innovation Corp., Tokyo (JP)

(72) Inventors: Shimpei KAWASHIMA, Kanagawa (JP); Satoshi ISOBE, Kanagawa (JP); Kazuya SUZUKI, Kanagawa (JP); Yoshihiro ONO, Kanagawa (JP)

(73) Assignee: FUJIFILM Business Innovation Corp., Tokyo (JP)

(21) Appl. No.: 17/582,004

(22) Filed: Jan. 24, 2022

(30) Foreign Application Priority Data
Sep. 24, 2021 (JP) 2021-156134

(51) Int. Cl. H04N 1/00; H04N 1/32

(52) U.S. Cl. CPC H04N 1/00037; H04N 1/00029; H04N 1/32625

(57) ABSTRACT

A control device includes a first control substrate and a second control substrate each of which includes a processor, a first communication interface, and a second communication interface, the first control substrate and the second control substrate being connected to each other via the first communication interfaces, in which the processor of the first control substrate or the processor of the second control substrate is configured to perform data communication via the second communication interfaces in a case where connection via the second communication interfaces is detected after an error of the data communication performed by the first communication interfaces is detected.

### CROSS-REFERENCE TO RELATED APPLICATIONS

This application is based on and claims priority under 35 USC 119 from Japanese Patent Application No. 2021-156134 filed Sep. 24, 2021.

### BACKGROUND

### (i) Technical Field

The present invention relates to a control device, an image forming apparatus, and a non-transitory computer readable medium storing a control program.

### (ii) Related Art

For example, a control device of a machine that includes a plurality of control units controlling units and in which the control units communicate with each other to operate the machine in cooperation with each other is described in JP1999-143842A. The control device includes a detection unit detecting an error of a control unit and a reset unit performing reset processing with respect to a control unit with an error when the detection unit detects the error of the control unit.

In addition, a communication device that can communicate with an external communication device is described in JP2004-350220A. The communication device includes an error detection unit that detects an error in communication between the communication device and the external communication device, a communication cutoff unit that cuts off logical connection between the communication device and the external communication device, and a communication error processing unit that monitors an error occurrence situation by means of the error detection unit after a transition from a first communication speed to a second communication speed, logically cuts off connection between the communication device and the external communication device by means of the communication cutoff unit depending on the situation, and establishes logical connection between the communication device and the external communication device again after performing setting that does not support the second communication speed.

### SUMMARY

Meanwhile, in many control devices, a controller substrate including a CPU that controls the entire processing and a substrate including a processor that performs control specialized in management of functions may be set as substrates separated from each other and the control substrates may be bus connected to each other via a relatively high-speed communication interface (communication I/F).

However, in the case of a configuration in which the two control substrates are bus connected to each other, a data communication error is likely to occur in comparison with a configuration in which one control substrate is provided with a CPU and a processor that manages functions. In this case, the apparatus cannot be used until the data communication error is resolved.

Aspects of non-limiting embodiments of the present disclosure relate to a control device, an image forming apparatus, and a non-transitory computer readable medium storing a control program with which it is possible to continuously use the control device even in a case where an error of data communication performed by communication I/Fs connecting two control substrates occurs.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a control device including a first control substrate and a second control substrate each of which includes a processor, a first communication interface, and a second communication interface, the first control substrate and the second control substrate being connected to each other via the first communication interfaces, in which the processor of the first control substrate or the processor of the second control substrate is configured to perform data communication via the second communication interfaces in a case where connection via the second communication interfaces is detected after an error of the data communication performed by the first communication interfaces is detected.

### BRIEF DESCRIPTION OF THE DRAWINGS

Exemplary embodiment(s) of the present invention will be described in detail based on the following figures, wherein:

FIG. 1 is a block diagram showing an example of an electrical configuration of an image forming apparatus according to a first exemplary embodiment;

FIG. 2 is a block diagram showing an example of the configuration of a control device according to the first exemplary embodiment;

FIG. 3 is a flowchart showing an example of the flow of processing performed by means of a control program according to the first exemplary embodiment;

FIG. 4 is a front view showing an example of a connection instruction screen according to the first exemplary embodiment;

FIG. 5 is a block diagram showing an example of the configuration of a control device according to a second exemplary embodiment;

FIG. 6 is a flowchart showing an example of the flow of processing performed by means of a control program according to the second exemplary embodiment; and

FIG. 7 is a front view showing an example of a connection instruction screen according to the second exemplary embodiment.

### DETAILED DESCRIPTION

Hereinafter, examples of exemplary embodiments of a technique according to the present disclosure will be described in detail with reference to the drawings. In addition, components and processing having the same operation, action, and function will be given the same reference numerals in all of the drawings and repetitive descriptions may be omitted. Each drawing is merely a drawing that schematically shows the technique according to the present disclosure to such an extent that the technique can be sufficiently understood. Therefore, the technique according to the present disclosure is not limited to examples shown in the drawings. In addition, in the present exemplary embodiments, the description of a configuration not directly related to the present invention and a well-known configuration may be omitted.

### First Exemplary Embodiment

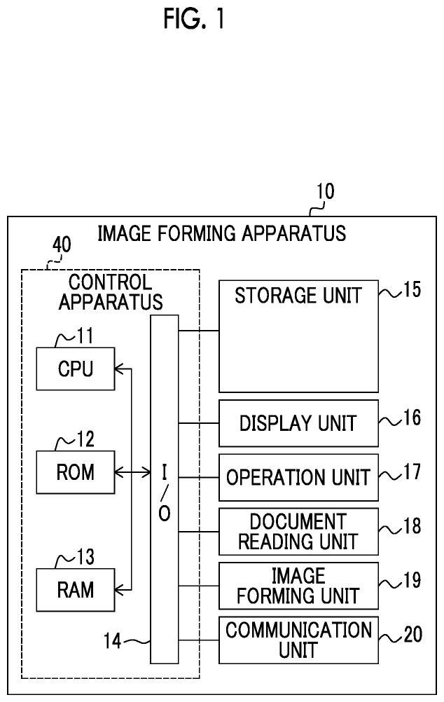

FIG. 1 is a block diagram showing an example of an electrical configuration of an image forming apparatus 10 according to a first exemplary embodiment.

As shown in FIG. 1, the image forming apparatus 10 according to the present exemplary embodiment includes a central processing unit (CPU) 11, a read-only memory (ROM) 12, a random-access memory (RAM) 13, an input and output interface (I/O) 14, a storage unit 15, a display unit 16, an operation unit 17, a document reading unit 18, an image forming unit 19, and a communication unit 20.

The CPU 11, the ROM 12, the RAM 13, and the I/O 14 are connected to each other via a bus. Each of functional units including the storage unit 15, the display unit 16, the operation unit 17, the document reading unit 18, the image forming unit 19, and the communication unit 20 is connected to the I/O 14. Each of the functional units can communicate with the CPU 11 via the I/O 14.

The CPU 11, the ROM 12, the RAM 13, and the I/O 14 constitute a control device 40. The control device 40 may be configured as a sub control unit that controls a part of the operation of the image forming apparatus 10 and may be configured as a part of a main control unit that controls the entire operation of the image forming apparatus 10. For example, an integrated circuit such as a large-scale integration (LSI) circuit or an integrated circuit (IC) chipset is used for a part or all of blocks of the control device 40. An individual circuit may be used for each of the blocks and a circuit partially or entirely integrated may also be used. The blocks may be integrally provided and a part of the blocks may be provided separately. In addition, a part of each of the above blocks may be provided separately. For control integration, a dedicated circuit or a general-purpose processor may be used instead of the LSI.

The ROM 12 stores a control program for the control device 40 according to the present exemplary embodiment. The control program may be installed in the control device 40 in advance, for example. The control program may be realized by being appropriately installed in the control device 40 after being stored in a non-volatile storage medium or being distributed via a network. Note that, examples of the non-volatile storage medium include a compact disc read-only memory (CD-ROM), a magneto-optical disk, an HDD, a digital versatile disc read-only memory (DVD-ROM), a flash memory, a memory card, and the like.

As the storage unit 15, for example, a hard disk drive (HDD), a solid state drive (SSD), a flash memory, or the like is used. The storage unit 15 stores a program, data, and the like related to various functions of the image forming apparatus 10.

As the display unit 16, for example, a liquid crystal display (LCD), an organic electroluminescence (EL) display, or the like is used. The display unit 16 may include a touch panel integrally. The operation unit 17 is provided with various operation keys such as a numeric keypad and a start key, for example. The display unit 16 and the operation unit 17 receive various instructions from a user of the image forming apparatus 10 as operation panels. The various instructions include, for example, an instruction to start the reading of a document, an instruction to start the copying of a document, and the like. The display unit 16 displays various items of information such as the result of processing performed in response to an instruction received from the user and notification with respect to the processing.

The document reading unit 18 takes in documents placed on a paper feed tray of an automatic document feeding device (not shown) provided at an upper portion of the image forming apparatus 10 in a one-by-one manner and optically reads the documents taken thereinto to obtain image information. Alternatively, the document reading unit 18 optically reads a document placed on a platen such as a platen glass to obtain image information.

The image forming unit 19 forms, on a paper sheet which is an example of a recording medium, an image based on the image information that is obtained by the document reading unit 18 reading the document. Note that, although the following description will be made by using an electrophotographic method as an example of a method of forming an image, another method such as an inkjet method may also be adopted.

In a case where an electrophotographic method is used as a method of forming an image, the image forming unit 19 includes a photosensitive drum, a charging device, an exposure device, a developing device, a transfer device, and a fixing device. The charging device applies a voltage to the photosensitive drum to charge a surface of the photosensitive drum. The exposure device forms an electrostatic latent image on the photosensitive drum by exposing the photosensitive drum charged by the charging device to light corresponding to the image information. The developing device forms a toner image on the photosensitive drum by developing the electrostatic latent image formed on the photosensitive drum with toner. The transfer device transfers the toner image formed on the photosensitive drum to a paper sheet. The fixing device fixes the toner image transferred to the paper sheet by heating and pressing the toner image.

The communication unit 20 is connected to a network such as the Internet, a local area network (LAN), and a wide area network (WAN) and can communicate with an external machine such as a personal computer (PC) via the network.

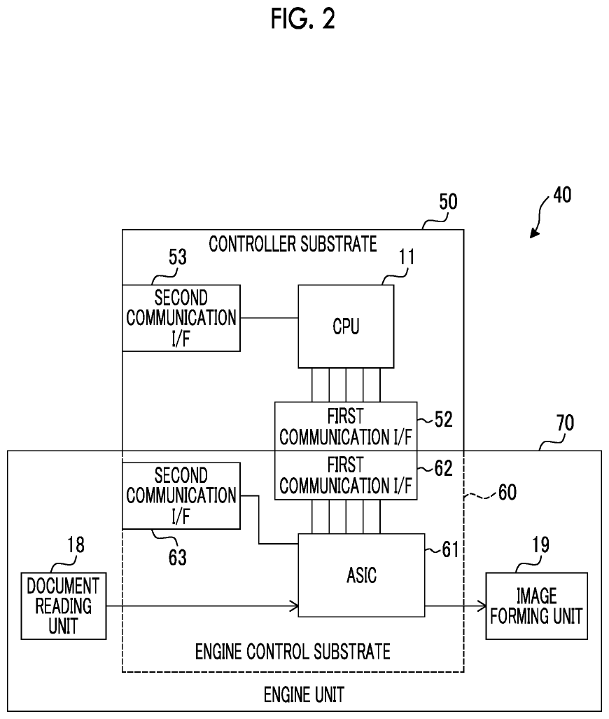

FIG. 2 is a block diagram showing an example of the configuration of the control device 40 according to the first exemplary embodiment.

As shown in FIG. 2, the control device 40 according to the present exemplary embodiment includes a controller substrate 50 and an engine control substrate 60. An engine unit 70 includes the engine control substrate 60, the document reading unit 18, and the image forming unit 19. The controller substrate 50 is an example of a first control substrate and the engine control substrate 60 is an example of a second control substrate. Although the ROM 12, the RAM 13, and the I/O 14 are included in the controller substrate 50, the description thereof will be omitted for the sake of simplicity.

The controller substrate 50 includes the CPU 11, a first communication interface (first communication I/F) 52, and a second communication interface (second communication I/F) 53. The CPU 11 is an example of a processor of the first control substrate and controls the entire operation of the image forming apparatus 10. In the controller substrate 50, (1) operation control of each device of the document reading unit 18 and the image forming unit 19, (2) image data processing, (3) performance of a document service, (4) communication with an external I/F, and the like are performed and signal communication for (1) and (2) is performed between the controller substrate 50 and the engine control substrate 60.

The engine control substrate 60 includes an application-specific integrated circuit (ASIC) 61, a first communication I/F 62, and a second communication I/F 63. The ASIC 61 is an example of a processor of the second control substrate and controls specific processing performed by the image forming apparatus 10 (in the present exemplary embodiment, image processing). The document reading unit 18 inputs image data to the ASIC 61 and the image forming unit 19 outputs image data after the image processing which is received from the ASIC 61.

The controller substrate 50 and the engine control substrate 60 are substrates separated from each other and the first communication I/F 52 and the first communication I/F 62 are connected thereto respectively, which allows the CPU 11 and the ASIC 61 to communicate with each other. For example, relatively high-speed communication I/Fs such as peripheral component interconnect-express (PCIe), universal serial bus (USB) 3.0 are applied to the first communication I/F 52 and the first communication I/F 62 and general-purpose I/Fs such as USB 3.0, USB 2.0, or Ethernet are applied to the second communication I/F 53 and the second communication I/F 63. The second communication I/F 53 and the second communication I/F 63 may be wireless I/Fs. The second communication I/F 53 and the second communication I/F 63 are respectively provided on the controller substrate 50 and the engine control substrate 60 in advance, as I/Fs used for a specific purpose. The specific purpose is, for example, connection with an external machine (an IC card reader, various optional products, a USB memory, or the like).

Meanwhile, as described above, in the case of a configuration in which the controller substrate 50 and the engine control substrate 60 are bus connected to each other, a data communication error is likely to occur in comparison with a configuration in which one control substrate is provided with the CPU 11 and the ASIC 61. In this case, the apparatus cannot be used until the data communication error is resolved.

Therefore, in a case where connection via the second communication I/Fs 53 and 63, which are included in the two control substrates respectively, is detected after an error of data communication performed by the first communication I/Fs 52 and 62 connecting the controller substrate 50 and the engine control substrate 60 is detected, the CPU 11 of the control device 40 according to the present exemplary embodiment executes a control program stored in the ROM 12 by writing the control program on the RAM 13 so as to perform the data communication via the second communication I/Fs 53 and 63. That is, in a case where an error occurs and recovery from the error is not made during use of the image forming apparatus 10, communication between the CPU 11 and the ASIC 61 is performed via the second communication I/Fs 53 and 63 instead of the first communication I/Fs 52 and 62 when connection via the second communication I/Fs 53 and 63 is detected. Accordingly, it is possible to continuously use the image forming apparatus 10 until repair to the image forming apparatus 10 (board replacement or the like) is performed.

Note that, although the CPU 11 detects an error in the above description, the ASIC 61 may detect an error. That is, the control program may be stored in a ROM of the engine control substrate 60 on the ASIC 61 side and the ASIC 61 may execute the control program. In this case, as with the CPU 11, in a case where connection via the second communication I/Fs 53 and 63, which are included in the two control substrates respectively, is detected after an error of data communication performed by the first communication I/Fs 52 and 62 connecting the controller substrate 50 and the engine control substrate 60 is detected, the ASIC 61 executes the control program so as to perform the data communication via the second communication I/Fs 53 and 63. Note that, both of the CPU 11 and the ASIC 61 may be able to execute the control program. In this case, one of the CPU 11 and the ASIC 61 may execute the control program and the other of the CPU 11 and the ASIC 61 may be set in advance as a backup.

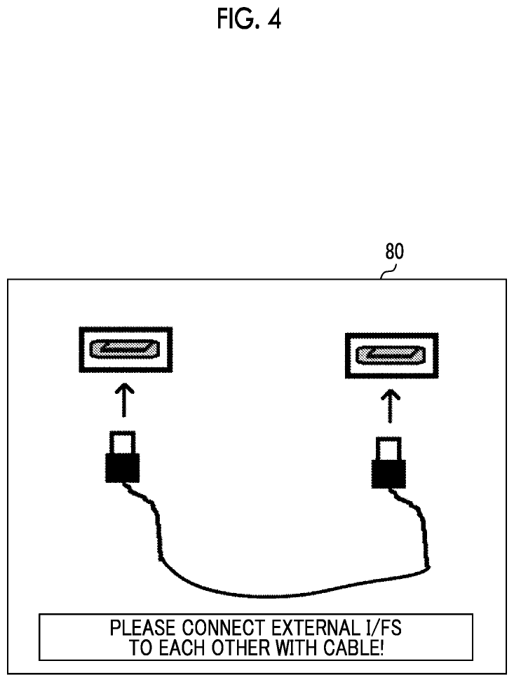

In addition, for example, in a case where a data communication error is detected, the CPU 11 or the ASIC 61 may output image information or text information to give an instruction to establish connection via the second communication I/Fs 53 and 63 as shown in FIG. 4, which will be described later.

In addition, the CPU 11 or the ASIC 61 may reactivate the control device 40 in a case where connection via the second communication I/Fs 53 and 63 is detected and may perform data communication via the second communication I/Fs 53 and 63 after the reactivation.

In addition, the CPU 11 or the ASIC 61 may determine that an error has occurred in a case where an error occurs again after the control device 40 is reactivated in response to occurrence of an error.

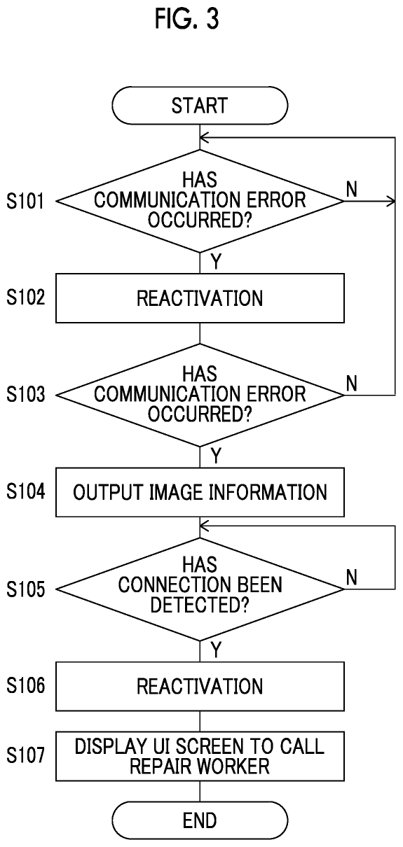

Next, with reference to FIG. 3, the operation of the control device 40 according to the first exemplary embodiment will be described.

FIG. 3 is a flowchart showing an example of the flow of processing performed by means of the control program according to the first exemplary embodiment.

First, in a case where the control device 40 is turned on, the control program is executed by the CPU 11 and the following steps are performed. Note that, although a case where the CPU 11 executes the control program will be described here, the same applies to a case where the ASIC 61 executes the control program.

In step S101 of FIG. 3, the CPU 11 determines whether or not an error of data communication performed by the first communication I/Fs 52 and 62 connecting the controller substrate 50 and the engine control substrate 60 has been detected. In a case where it is determined that a communication error has been detected (in a case where the result of the determination is positive), the processing proceeds to step S102 and in a case where it is determined that a communication error has not been detected (in a case where the result of the determination is negative), the processing stands by at step S101.

In step S102, the CPU 11 reactivates the control device 40 and attempts recovery from the communication error by means of the reactivation.

In step S103, the CPU 11 determines again whether or not an error of data communication performed by the first communication I/Fs 52 and 62 has been detected. In a case where it is determined that a communication error has been detected (in a case where the result of the determination is positive), the processing proceeds to step S104 and in a case where it is determined that a communication error has not been detected (in a case where the result of the determination is negative), the processing returns to step S101 and stands by at step S101.

In step S104, for example, the CPU 11 causes the display unit 16 to output image information or text information to give an instruction to establish connection via the second communication I/Fs 53 and 63 as shown in FIG. 4.

FIG. 4 is a front view showing an example of a connection instruction screen 80 according to the first exemplary embodiment.

The connection instruction screen 80 shown in FIG. 4 is a screen including the image information or the text information for an instruction to establish connection via the second communication I/Fs 53 and 63 and is displayed by the display unit 16. In this example, a message “please connect external I/Fs to each other with a cable!” is displayed together with image information showing the second communication I/Fs 53 and 63.

In step S105, the CPU 11 determines whether or not connection via the second communication I/Fs 53 and 63 has been detected. In a case where it is determined that the connection via the second communication I/Fs 53 and 63 has been detected (in a case where the result of the determination is positive), the processing proceeds to step S106 and in a case where it is determined that the connection via the second communication I/Fs 53 and 63 has not been detected (in a case where the result of the determination is negative), the processing stands by at step S105.

In a case where the connection is detected in step S105, the CPU 11 automatically reactivates the control device 40 and enables data communication via the second communication I/Fs 53 and 63 in step S106. That is, after the reactivation, communication between the CPU 11 and the ASIC 61 is performed via the second communication I/Fs 53 and 63 instead of the first communication I/Fs 52 and 62.

In step S107, the CPU 11 causes the display unit 16 to output information to give an instruction to call a repair worker (also called a serviceman) and a series of processing in the control program is terminated. The display unit 16 displays the information on a UI (user interface). For example, a message such as “the board needs to be replaced and call a repair worker!” is displayed.

As described above, according to the present exemplary embodiment, communication between the CPU and the ASIC is performed via the second communication I/Fs instead of the first communication I/Fs in a case where connection via the second communication I/Fs is detected after an error of data communication performed by the first communication I/Fs is detected. Accordingly, it is possible to continuously use the image forming apparatus until the image forming apparatus is repaired.

### Second Exemplary Embodiment

In the first exemplary embodiment as above, a configuration in which each control substrate includes one second communication I/F has been described. In the second exemplary embodiment, a configuration in which each control substrate includes a plurality of second communication I/Fs will be described.

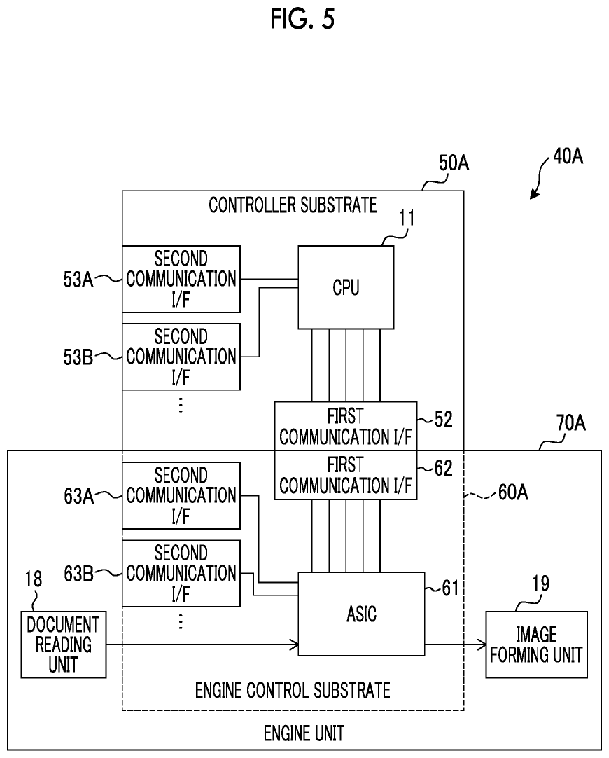

FIG. 5 is a block diagram showing an example of the configuration of a control device 40A according to the second exemplary embodiment.

As shown in FIG. 5, the control device 40A according to the present exemplary embodiment includes a controller substrate 50A and an engine control substrate 60A. An engine unit 70A includes the engine control substrate 60A, the document reading unit 18, and the image forming unit 19. Although the ROM 12, the RAM 13, and the I/O 14 are included in the controller substrate 50A, the description thereof will be omitted for the sake of simplicity. Note that, the same components as the components in the control device 40 according to the first exemplary embodiment will be given the same reference numerals and repetitive descriptions thereof will be omitted.

The controller substrate 50A includes the CPU 11, the first communication I/F 52, and a plurality of second communication I/Fs 53A, 53B, . . . and so forth.

The engine control substrate 60A includes the ASIC 61, the first communication I/F 62, and a plurality of second communication I/Fs 63A, 63B, . . . and so forth. Note that, in the present exemplary embodiment, the plurality of second communication I/Fs 63A, 63B, . . . and so forth are provided to respectively correspond to the plurality of second communication I/Fs 53A, 53B, . . . and so forth.

In a case where a data communication error is detected, the CPU 11 or the ASIC 61 select a second communication I/F that satisfies a predetermined condition, from among the plurality of second communication I/Fs 53A, 53B, . . . and so forth. Then, in a case where connection via the selected second communication I/F is detected, the CPU 11 or the ASIC 61 performs data communication via the second communication I/F. The predetermined condition includes, for example, a condition that the communication speed of the second communication I/F is the highest among the communication speeds of the plurality of second communication I/Fs 53A, 53B, . . . and so forth. Specifically, in a case where the second communication I/F 53A is USB 3.0 and the second communication I/F 53B is USB 2.0, the second communication I/F 53A is selected. Note that, it will be assumed that the second communication I/F 63A on the ASIC 61 corresponds to USB 3.0 and the second communication I/F 63B corresponds to USB 2.0.

In addition, the predetermined condition may include a condition that the communication I/F is one of the plurality of second communication I/Fs 53A, 53B, . . . and so forth that is not in use for a predetermined purpose. As described above, the predetermined purpose herein includes, for example, connection with an external machine (an IC card reader, various optional products, a USB memory, or the like). Specifically, in a case where the second communication I/F 53A has been connected to an external machine, the second communication I/F 53B is selected.

In addition, the predetermined condition may include a condition that the communication speed of the communication I/F is the highest among two or more of the plurality of second communication I/Fs 53A, 53B, . . . and so forth that are not in use for a predetermined purpose. Specifically, in a case where the second communication I/Fs 53A and 53B of the plurality of second communication I/Fs 53A, 53B, . . . and so forth are not in use, the second communication I/F 53A is USB 3.0, and the second communication I/F 53B is USB 2.0, the second communication I/F 53A is selected.

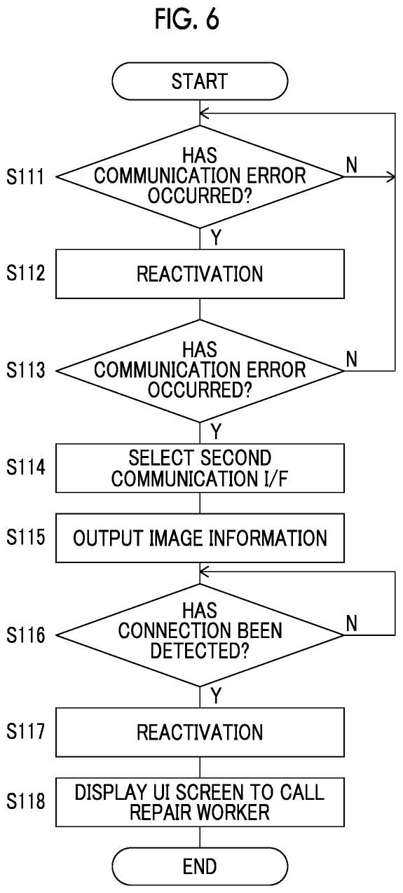

Next, with reference to FIG. 6, the operation of the control device 40A according to the second exemplary embodiment will be described.

FIG. 6 is a flowchart showing an example of the flow of processing performed by means of the control program according to the second exemplary embodiment.

First, in a case where the control device 40A is turned on, the control program is executed by the CPU 11 and the following steps are performed. Note that, although a case where the CPU 11 executes the control program will be described here, the same applies to a case where the ASIC 61 executes the control program.

In step S111 of FIG. 6, the CPU 11 determines whether or not an error of data communication performed by the first communication I/Fs 52 and 62 connecting the controller substrate 50A and the engine control substrate 60A has been detected. In a case where it is determined that a communication error has been detected (in a case where the result of the determination is positive), the processing proceeds to step S112 and in a case where it is determined that a communication error has not been detected (in a case where the result of the determination is negative), the processing stands by at step S111.

In step S112, the CPU 11 reactivates the control device 40A and attempts recovery from the communication error by means of the reactivation.

In step S113, the CPU 11 determines again whether or not an error of data communication performed by the first communication I/Fs 52 and 62 has been detected. In a case where it is determined that a communication error has been detected (in a case where the result of the determination is positive), the processing proceeds to step S114 and in a case where it is determined that a communication error has not been detected (in a case where the result of the determination is negative), the processing returns to step S111 and stands by at step S111.

In step S114, the CPU 11 selects a second communication I/F that satisfies the predetermined condition from among the plurality of second communication I/Fs 53A, 53B, . . . and so forth. As described above, the predetermined condition includes, for example, a condition that the communication speed of the second communication I/F is the highest. Here, the second communication I/F 53A is selected and the second communication I/F 63A on the ASIC 61 is the target of the connection.

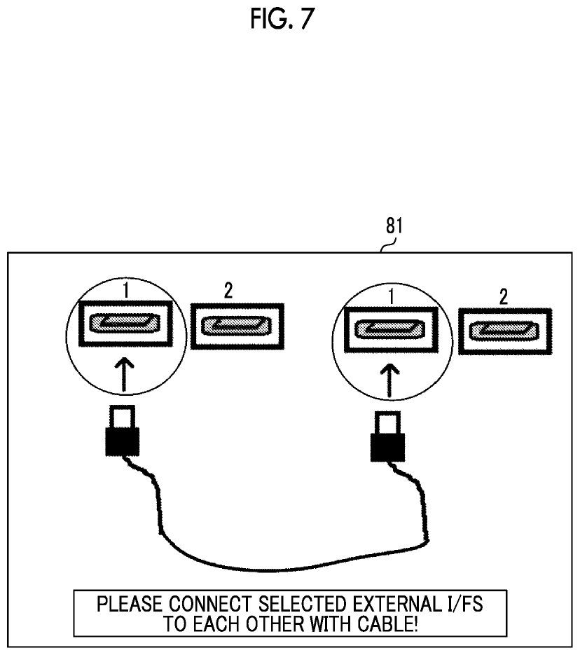

In step S115, for example, the CPU 11 causes the display unit 16 to output image information or text information to give an instruction to establish connection via the selected second communication I/Fs 53A and 63A as shown in FIG. 7.

FIG. 7 is a front view showing an example of a connection instruction screen 81 according to the second exemplary embodiment.

The connection instruction screen 81 shown in FIG. 7 is a screen including the image information or the text information for an instruction to establish connection via the selected second communication I/Fs 53A and 63A and is displayed by the display unit 16. In this example, a message “please connect selected external I/Fs to each other with a cable!” is displayed together with image information explicitly showing the selected second communication I/Fs 53A and 63A (second communication I/Fs denoted by “1”).

In step S116, the CPU 11 determines whether or not connection via the second communication I/Fs 53A and 63A has been detected. In a case where it is determined that the connection via the second communication I/Fs 53A and 63A has been detected (in a case where the result of the determination is positive), the processing proceeds to step S117 and in a case where it is determined that the connection via the second communication I/Fs 53A and 63A has not been detected (in a case where the result of the determination is negative), the processing stands by at step S116.

In a case where the connection is detected in step S116, the CPU 11 automatically reactivates the control device 40A and enables data communication via the second communication I/Fs 53A and 63A in step S117. That is, after the reactivation, communication between the CPU 11 and the ASIC 61 is performed via the second communication I/Fs 53A and 63A instead of the first communication I/Fs 52 and 62.

In step S118, the CPU 11 causes the display unit 16 to output information to give an instruction to call a repair worker (also called a serviceman) and a series of processing in the control program is terminated.

As described above, according to the present exemplary embodiment, in a case where communication between the CPU and the ASIC is performed via the second communication I/Fs instead of the first communication I/Fs, the second communication I/Fs of which the communication speed is the highest are selected, for example. Therefore, a decrease in data communication performance is suppressed.

Note that, in the above-described exemplary embodiments, cases where the control device according to the exemplary embodiments is applied to the image forming apparatus have been described. However, it is a matter of course that the control device may not be applied to the image forming apparatus and can be applied to another information processing apparatus such as a server computer, a personal computer, or the like.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Hereinabove, the control device according to the exemplary embodiments and the image forming apparatus including the control device have been described as examples. The exemplary embodiments may be implemented by a program causing a computer to perform the functions of the control device. The exemplary embodiments may be implemented by a non-transitory computer readable medium storing the program.

The configuration of the control device described in the above-described exemplary embodiments is merely an example and may be changed depending on the situation without departing from the scope of the present invention.

The flow of processing in the program described in the above-described exemplary embodiments is also merely an example, and deletion of an unnecessary step, addition of a new step, and a change in procedure of processing may be made without departing from the scope of the present invention.

In addition, in the above-described exemplary embodiments, a case where the processing according to the exemplary embodiments is realized by a software configuration using a computer with execution of a program has been described. However, the present invention is not limited thereto. The exemplary embodiments may be realized by, for example, a hardware configuration or a combination of a hardware configuration and a software configuration.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control device comprising:
a first control substrate and a second control substrate each of which includes a processor, a first communication interface, and a second communication interface, the first control substrate and the second control substrate being connected to each other via the first communication interfaces,
wherein the processor of the first control substrate or the processor of the second control substrate is configured to:
perform data communication via the second communication interfaces in a case where connection via the second communication interfaces is detected after an error of the data communication performed by the first communication interfaces is detected.

2. The control device according to claim 1, wherein the processor of the first control substrate or the processor of the second control substrate is configured to:
output image information or text information to give an instruction to establish the connection via the second communication interfaces in a case where an error of the data communication is detected.

3. The control device according to claim 2, wherein the processor of the first control substrate or the processor of the second control substrate is configured to:
reactivate the control device and perform the data communication via the second communication interfaces after the reactivation in a case where the connection via the second communication interfaces is detected.

4. The control device according to claim 1, wherein the processor of the first control substrate or the processor of the second control substrate is configured to:
determine that the error has occurred in a case where the error occurs again after the control device is reactivated in response to occurrence of the error.

5. The control device according to claim 2, wherein the processor of the first control substrate or the processor of the second control substrate is configured to:
determine that the error has occurred in a case where the error occurs again after the control device is reactivated in response to occurrence of the error.

6. The control device according to claim 3, wherein the processor of the first control substrate or the processor of the second control substrate is configured to:
determine that the error has occurred in a case where the error occurs again after the control device is reactivated in response to occurrence of the error.

7. The control device according to claim 1,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

8. The control device according to claim 2,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

9. The control device according to claim 3,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

10. The control device according to claim 4,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

11. The control device according to claim 5,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

12. The control device according to claim 6,
wherein each of the first control substrate and the second control substrate is provided with a plurality of second communication interfaces, and
the processor of the first control substrate or the processor of the second control substrate is configured to:
select a second communication interface satisfying a predetermined condition from among the plurality of second communication interfaces in a case where the error of the data communication is detected.

13. The control device according to claim 7,
wherein the predetermined condition includes a condition that a communication speed of the second communication interface is highest among the plurality of second communication interfaces.

14. The control device according to claim 8,
wherein the predetermined condition includes a condition that a communication speed of the second communication interface is highest among the plurality of second communication interfaces.

15. The control device according to claim 9,
wherein the predetermined condition includes a condition that a communication speed of the second communication interface is highest among the plurality of second communication interfaces.

16. The control device according to claim 7,
wherein the predetermined condition includes a condition that the second communication interface is one of the plurality of second communication interfaces that is not in use for a predetermined purpose.

17. The control device according to claim 7,
wherein the predetermined condition includes a condition that a communication speed of the second communication interface is highest among two or more of the plurality of second communication interfaces that are not in use for a predetermined purpose.

18. The control device according to claim 1,
wherein the processor of the first control substrate is a CPU, and
the processor of the second control substrate is an ASIC.

19. An image forming apparatus comprising a control device including a first control substrate and a second control substrate,
wherein each of the first control substrate and the second control substrate includes a processor, a first communication interface, and a second communication interface, and the first control substrate and the second control substrate are connected to each other via the first communication interfaces, and
the processor of the first control substrate or the processor of the second control substrate is configured to:
perform control to cause a display unit to display image information or text information to give an instruction to establish connection via the second communication interfaces in a case where an error of data communication performed by the first communication interfaces is detected; and
perform the data communication via the second communication interfaces in a case where connection via the second communication interfaces is detected.

20. A non-transitory computer readable medium storing a control program for a control device including a first control substrate and a second control substrate each of which includes, a processor, a first communication interface, and a second communication interface, the first control substrate and the second control substrate being connected to each other via the first communication interfaces, the control program causing a computer to execute a process comprising:
performing data communication via the second communication interfaces in a case where connection via the second communication interfaces is detected after an error of the data communication performed by the first communication interfaces is detected.
